(19) United States
(12) Patent Application Publication
(10) Pub. No.: US 2012/0320166 A1
(43) Pub. Date: Dec. 20, 2012

(54) IMAGE PROCESSING APPARATUS, IMAGE PROCESSING METHOD, AND PROGRAM

(76) Inventors: Nobuo UEKI, Tokyo (JP); Hideki WATANABE, Saitama (JP)

(21) Appl. No.: 13/490,969

(22) Filed: Jun. 7, 2012

(30) Foreign Application Priority Data
Jun. 17, 2011 (JP) 2011-135623

(51) Int. Cl. H04N 13/04

(52) U.S. Cl. 348/51; 348/E13.075

(57) ABSTRACT

An image processing apparatus that outputs, if three-dimensional stereoscopically viewable left-eye and right-eye images are not alternately supplied at accurate timings, only one of the three-dimensional stereoscopically viewable left-eye or right-eye image when the three-dimensional stereoscopically viewable left-eye and right-eye images are supplied.

### BACKGROUND

The present technology relates to an image processing apparatus, an image processing method, and a program, and more particularly, to an image processing apparatus, an image processing method, and a program capable of displaying an image being viewed without error, in a simply way, even when supply timings of left-eye and right-eye images configured to realize a three-dimensional view are disturbed.

As games or movies viewed with a 3D (3-dimensional) stereoscopically viewable image have increased in popularity, display techniques of displaying a 3D stereoscopically viewable image have become important.

Systems displaying a 3D stereoscopically viewable image are broadly classified into polarized glasses type and liquid crystal shutter glasses type systems, and both convert left-eye and right-eye images into images suitable for display devices to display the images in accordance with various display schemes in which left-eye and right-eye images are viewed with left and right eyes at appropriate timings, respectively.

As a technique for displaying left-eye and right-eye images at appropriate timings, a technique of applying a low pass filter (LPF) to left-eye and right-eye images and displaying each of the left-eye and right-eye images at least twice continuously has been suggested (see Japanese Unexamined Patent Application Publication No. 2011-040946).

### SUMMARY

In the systems displaying a 3D stereoscopically viewable image, however, when glasses are used, left-eye and right-eye images may somehow be disturbed, and the switching timings of the left-eye and right-eye images may not be synchronized. In this case, a viewer using the glasses may view a backward sunken image that was originally supposed to be a forward protruding image, or a forward protruding image that was originally supposed to be a backward sunken image.

It is desirable to provide an image processing apparatus, an image processing method, and a program capable of displaying 3D stereoscopic left-eye and right-eye images so that a user can view the appropriate left-eye and right-eye images even when the supply timings of the left-eye and right-eye images are for some reason disturbed in a step of inputting the left-eye and right-eye images.

According to a first embodiment of the present technology, there is provided an image processing apparatus that outputs, if three-dimensional stereoscopically viewable left-eye and right-eye images are not alternately supplied at accurate timings, only one of the three-dimensional stereoscopically viewable left-eye or right-eye image when the three-dimensional stereoscopically viewable left-eye and right-eye images are supplied.

According to a second embodiment of the present technology, there is provided an image processing apparatus including an abnormal signal detection unit that detects a signal indicating that three-dimensional stereoscopically viewable left-eye and right-eye images are not alternately supplied at accurate timings, and an output unit that outputs, when the abnormal signal detection unit detects the signal indicating that the three-dimensional stereoscopically viewable left-eye and right-eye images are not alternately output at the accurate timings, only one of the left-eye or right-eye image when the three-dimensional stereoscopically viewable left-eye and right-eye images are supplied.

The image processing apparatus may further include a determination unit that determines, when the three-dimensional stereoscopically viewable left-eye and right-eye images are alternately supplied, whether timing signals indicating supply timings of the left-eye image and the right-eye image are correct, and a timing signal generation unit that independently generates the supply timing signals. When the abnormal signal detection unit does not detect the signal indicating that the three-dimensional stereoscopically viewable left-eye and right-eye images are not alternately output at the accurate timings and the determination unit determines that the supply timing signals are not correct, the output unit may acquire the three-dimensional stereoscopically viewable left-eye and right-eye images based on the timing signals generated by the timing signal generation unit and output the acquired three-dimensional stereoscopically viewable left-eye and right-eye images at predetermined timings.

The output unit may acquire the three-dimensional stereoscopically viewable left-eye and right-eye images based on the timing signals, and convert and output a frame rate.

The image processing apparatus may further include a storage unit that stores the three-dimensional stereoscopically viewable left-eye and right-eye images acquired by the output unit based on the timing signals, and a storage control unit that stores the three-dimensional stereoscopically viewable left-eye and right-eye images acquired by the output unit in the storage unit based on the timing signals and, when the output unit converts and outputs the frame rate, reads one of the three-dimensional stereoscopically viewable left-eye or right-eye image stored in the storage unit and supplies the read image to the output unit.

When the abnormal signal detection unit detects the signal indicating that the three-dimensional stereoscopically viewable left-eye and right-eye images are not alternately output at the accurate timings, the storage control unit may store only one of the three-dimensional stereoscopically viewable left-eye or right-eye image acquired by the output unit in the storage unit based on the timing signals, read only one of the three-dimensional stereoscopically viewable left-eye or right-eye image stored in the storage unit, and output the read image to the output unit, and the output unit may convert the frame rate and output only one of the left-eye or right-eye image.

According to the second embodiment of the present technology, there is provided an image processing method including detecting, with an abnormal signal detection unit that detects a signal indicating that three-dimensional stereoscopically viewable left-eye and right-eye images are not alternately supplied at accurate timings, the signal indicating that the three-dimensional stereoscopically viewable left-eye and right-eye images are not alternately supplied at the accurate timings, and outputting, with an output unit that outputs, if the abnormal signal detection unit detects the signal indicating that the three-dimensional stereoscopically viewable left-eye and right-eye images are not alternately output at the accurate timings, only one of the left-eye or right-eye image when the three-dimensional stereoscopically viewable left-eye and right-eye images are supplied, only one of the left-eye or right-eye image when the three-dimensional stereoscopically viewable left-eye and right-eye images are supplied if the signal indicating that the three-dimensional stereoscopically viewable left-eye and right-eye images are not alternately output at the accurate timings is detected by the process of the detecting step.

According to the second embodiment of the present technology, there is provided a program causing a computer, which controls an image processing apparatus including an abnormal signal detection unit that detects a signal indicating that three-dimensional stereoscopically viewable left-eye and right-eye images are not alternately supplied at accurate timings, and an output unit that outputs, if the abnormal signal detection unit detects the signal indicating that the three-dimensional stereoscopically viewable left-eye and right-eye images are not alternately output at the accurate timings, only one of the left-eye or right-eye image when the three-dimensional stereoscopically viewable left-eye and right-eye images are supplied, to execute a process comprising detecting, with the abnormal signal detection unit, the signal indicating that the three-dimensional stereoscopically viewable left-eye and right-eye images are not alternately supplied at the accurate timings, and if the signal indicating that the three-dimensional stereoscopically viewable left-eye and right-eye images are not alternately output at the accurate timings is detected by the process of the detecting step, outputting, with the output unit, only one of the left-eye or right-eye image when the three-dimensional stereoscopically viewable left-eye and right-eye images are supplied.

According to the first embodiment of the present technology described above, if three-dimensional stereoscopically viewable left-eye and right-eye images are not alternately supplied at accurate timings, only one of the three-dimensional stereoscopically viewable left-eye or right-eye image is output when the three-dimensional stereoscopically viewable left-eye and right-eye images are supplied.

According to the second embodiment of the present technology described above, when a signal indicating that the three-dimensional stereoscopically viewable left-eye and right-eye images are not alternately supplied at the accurate timings is detected and a signal indicating that the three-dimensional stereoscopically viewable left-eye and right-eye images are not alternately output is detected, only one of the left-eye or right-eye image is output when the three-dimensional stereoscopically viewable left-eye and right-eye images are supplied.

The image processing apparatus according to the embodiments of the present technology may be an independent apparatus or a block that performs image processing.

According to the embodiments of the present technology described above, an image can be viewed without error even when supply timings of left-eye and right-eye images configured to realize a three-dimensional view are disturbed.

### BRIEF DESCRIPTION OF THE DRAWINGS

FIG. 1 is a diagram illustrating an example of the configuration of an image encoding apparatus to which an image processing apparatus according to an embodiment of the present technology is applied;

FIG. 2 is a diagram illustrating an example of the configuration of an LR flag detection unit;

FIG. 3 is a diagram illustrating an example of the configuration of a detection result determination unit;

FIG. 4 is a diagram illustrating input and output signals of the detection result determination unit;

FIG. 5 is a diagram illustrating an example of the configuration of an LR flag self-running signal generation unit;

FIG. 6 is a flowchart illustrating an LR flag detection process:

FIG. 7 is a diagram illustrating waveforms when an LR flag input signal is normal;

FIG. 8 is a diagram illustrating waveforms when the LR flag input signal is abnormal:

FIG. 9 is a flowchart illustrating an LR flag self-running signal generation process;

FIG. 10 is a flowchart illustrating a detection result determination process;

FIG. 11 is a diagram illustrating waveforms when abnormality occurs in the LR flag input signal and the LR flag self-running signal is used;

FIG. 12 is a diagram illustrating a process of reading only a left-eye image when a non-standard signal determination flag is a High signal;

FIG. 13 is a flowchart illustrating an image outputting process;

FIG. 14 is a flowchart illustrating the image outputting process; and

FIG. 15 is a diagram illustrating an example of the configuration of a general personal computer.

### DETAILED DESCRIPTION OF THE EMBODIMENTS

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

### Example of Configuration of Image Processing Apparatus According to Embodiment of Present Technology

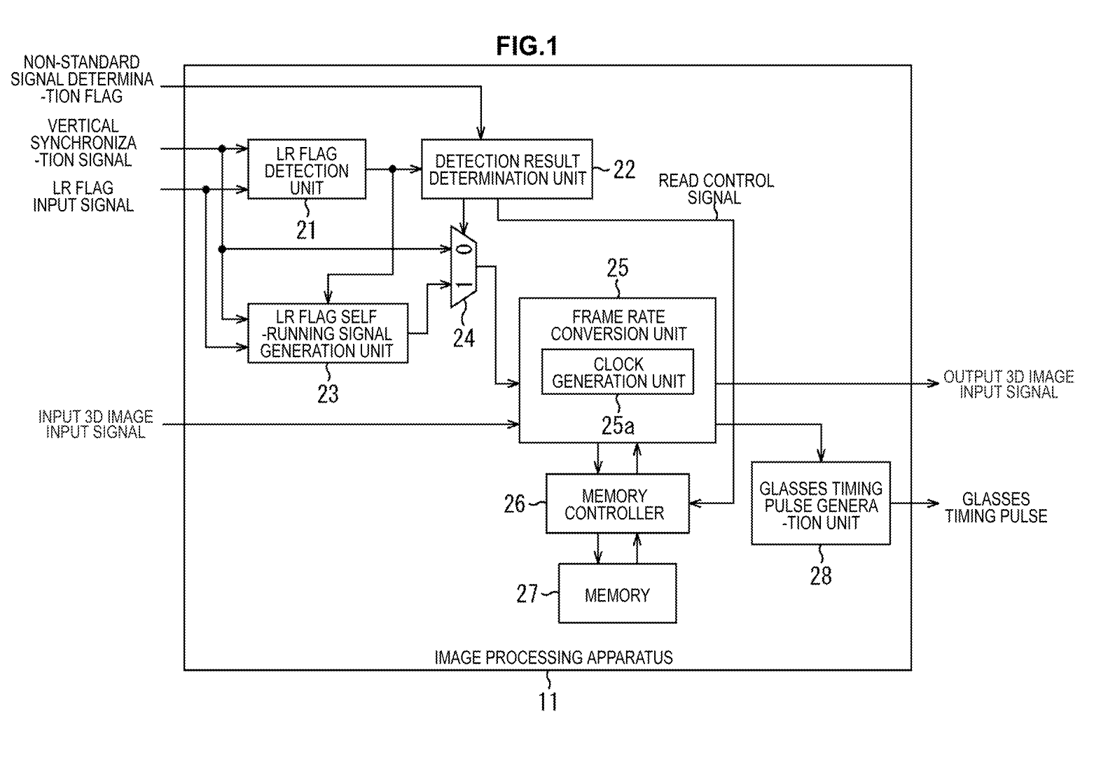

An example of the configuration of an image processing apparatus displaying a three-dimensional stereoscopic image according to an embodiment of the present technology will be described with reference to FIG. 1.

An image processing apparatus 11 converts the frame rate of a 3D image signal configured by input left-eye and right-eye images and displays a stereoscopic image which a viewer can view using dedicated glasses. The image processing apparatus 11 is, for example, a television receiver. The image processing apparatus 11 includes an LR flag detection unit 21, a detection result determination unit 22, an LR flag self-running signal generation unit 23, a selector 24, a frame rate conversion unit 25, a memory controller 26, a memory 27, a glasses timing pulse generation unit 28.

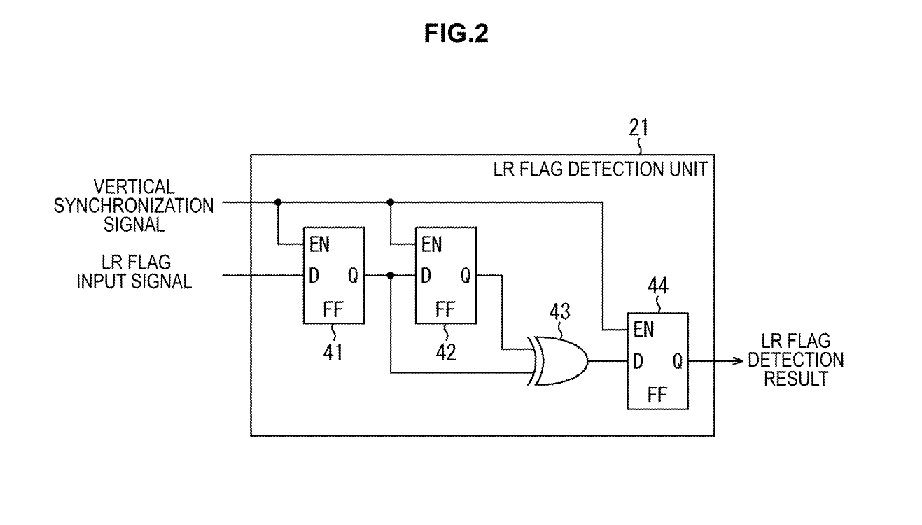

The LR flag detection unit 21 detects abnormality of an LR flag input signal based on the LR flag input signal indicating supply timings of a vertical synchronization signal, a left-eye image, and a right-eye image supplied when the 3D image signal is input. Here, the LR flag input signal refers to a pulse signal configured such that input timings of the left-eye and right-eye images are output as Low and High signals, respectively, at the input timing of the vertical synchronization signal, and the period of the High signal is the same as the period of the Low signal. That is, the LR flag detection unit 21 detects whether the abnormality of the LR flag input signal occurs by determining whether the LR flag input signal is supplied at a suitable interval while the supply timings of the left-eye and right-eye images are switched based on the vertical synchronization signal. The LR flag detection unit 21 supplies a signal, which indicates whether the abnormality is detected, as the LR flag detection result to the detection result determination unit 22 and the LR flag self-running signal generation unit 23. The detailed configuration of the LR flag detection unit 21 will be described later with reference to FIG. 2.

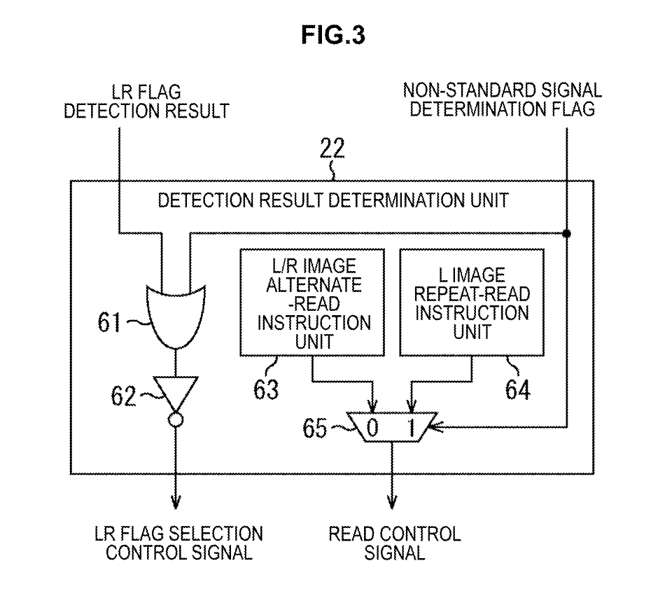

The detection result determination unit 22 generates an LR flag selection control signal based on the detection result supplied from the LR flag detection unit 21 and a non-standard signal determination flag, and then supplies the generated LR flag selection control signal to the selector 24. The detection result determination unit 22 supplies the memory controller 26 with a read control signal configured to give instructions to alternately read the L and R images or to read only the L image. The detailed configuration of the detection result determination unit 22 will be described later with reference to FIG. 3.

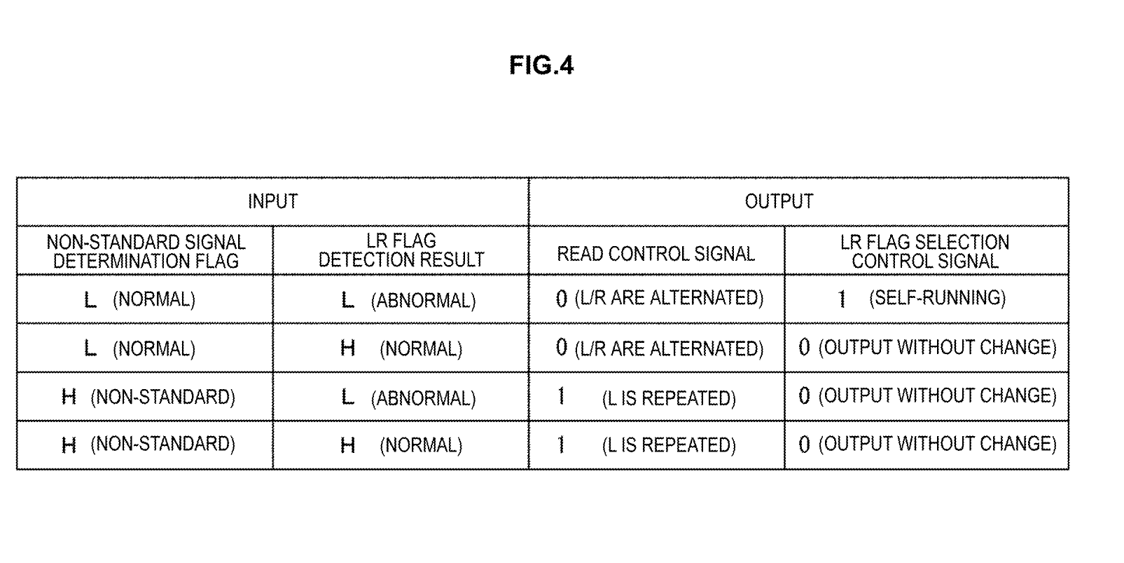

The LR flag self-running signal generation unit 23 generates an LR flag self-running signal independent from the LR flag input signal based on the vertical synchronization signal and the LR flag input signal, and then supplies the generated LR flag self-running signal to the selector 24. The detailed configuration of the LR flag self-running signal generation unit 23 will be described later with reference to FIG. 4.

The selector 24 selects one of the LR flag input signal or the LR flag self-running signal supplied from the LR flag self-running signal generation unit 23 based on the LR flag selection control signal supplied from the detection result determination unit 22, and then supplies the selected signal to the frame rate conversion unit 25.

The frame rate conversion unit 25 acquires the input 3D image signal with reference to one of the LR flag signal or the LR flag self-running signal supplied from the selector 24 and controls the memory controller 26 such that the memory controller 26 stores the acquired 3D image signal in the memory 27. The frame rate conversion unit 25 controls the memory controller 26 based on a clock signal generated by a clock generation unit 25a included in the frame rate conversion unit 25 such that the memory controller 26 reads the left-eye or right-eye image of the 3D image signal from the memory 27 at a suitable timing corresponding to a frame rate to be converted, and then outputs the left-eye or right-eye image. The frame rate conversion unit 25 supplies the glasses timing pulse generation unit 28 with information regarding the output timing of the left-eye or right-eye image.

The memory controller 26 stores, in the memory 27, the 3D image signal configured by the left-eye or right-eye image supplied under the control of the frame rate conversion unit 25. When the read control signal supplied from the detection result determination unit 22 is the read control signal configured to give the instructions to alternately read the L and R images, the memory controller 26 alternately reads the left-eye and right-eye images stored in the memory 27 at a suitable conversion timing of a frame rate. Further, when the read control signal supplied from the detection result determination unit 22 is the read control signal configured to give the instructions to read only the L image, the memory controller 26 reads only the left-eye image between the left-eye and right-eye images stored in the memory 27 at a suitable conversion timing of the frame rate.

The glasses timing pulse generation unit 28 generates a glasses timing pulse based on a signal for the output timings of the left-eye and right-eye images supplied from the frame rate conversion unit 25, and then supplies the generated glasses timing pulse to glasses (not shown).

### Example of Configuration of LR Flag Detection Unit

Next, an example of the configuration of the LR flag detection unit 21 will be described with reference to FIG. 2.

The LR flag detection unit 21 includes flip-flop circuits (FE) 41 and 42, an EXOR circuit 43, and an FF 44. At a supply timing of the vertical synchronization signal to an enable terminal EN, the FF 41 outputs a signal latched until the supply timing of the vertical synchronization signal from an output terminal Q to one of the input terminals of the FF 42 and the EXOR circuit 43. The FF 41 latches and stores the LR flag input signal input into a data terminal D. At a supply timing of the vertical synchronization signal to the enable terminal EN, the FF 42 outputs a signal latched until the supply timing of the vertical synchronization signal from the output terminal Q to the other input terminal of the EXOR circuit 43. The FF 42 latches and stores an output signal which is input from the output terminal Q of the FF 41 to a data terminal D. The EXOR circuit 43 compares the signals supplied from the output terminals Q of the FF 41 and FF 42 to each other. When these signals are not identical with each other, the EXOR circuit 43 outputs the High signal. When these signals are identical with each other, the EXOR circuit 43 outputs a Low signal. The FF 44 latches and stores an output signal supplied from the EXOR circuit 43 to a data terminal D at a supply timing of the vertical synchronization signal to an enable terminal EN and outputs the stored signal from an output terminal Q.

That is, the output signals of the FF 41 and FF 42 can be understood as signals with the immediately previous waveform and the current waveform, respectively. Therefore, when the EXOR circuit 43 determines that the output signals are not identical with each other and the High signal is output, it can be determined that the output signals are normal signals. That is, when the output signal supplied from the FF 44 is the High signal, the LR flag detection unit 21 outputs a signal, which indicates that the LF flag input signal is normal, as an LF flag detection result. Conversely, when the output signal supplied from the FF 44 is the Low signal, the LR flag detection unit 21 outputs a signal, which indicates that the LF flag input signal is abnormal, as an LF flag detection result.

### Example of Configuration of Detection Result Determination Unit

Next, an example of the configuration of the detection result determination result 22 will be described with reference to FIG. 3.

The detection result determination unit 22 includes an OR circuit 61, an inversion circuit 62, an L/R image alternate-read instruction unit 63, an L image repeat-read instruction unit 64, and a selector 65. The OR circuit 61 outputs the High signal, when at least one of the LR flag detection result supplied from the LR flag detection unit 21 or the non-standard signal determination flag is the High signal. Otherwise, the OR circuit 61 outputs the Low signal. Here, the non-standard signal determination flag refers to a signal that is supplied as the High signal when an input 3D image signal is switched, a resolution is changed, or the frequency of the 3D image signal is converted. Therefore, when the non-standard signal determination flag becomes the High signal, it can be generally considered that the 3D image signal is not supplied at a correct timing. The inversion circuit 62 inverts the output signal from the OR circuit 61 and outputs the inverted signal as an LR flag selection control signal to the selector 24. That is, only when the LR flag detection result is the Low signal and the non-standard signal determination flag is the Low signal, the inversion circuit 62 outputs the LR flag selection control signal as the High signal. Otherwise, the Low signal is output.

The L/R image alternate-read instruction unit 63 outputs an L/R image alternate-read instruction command to alternately read the left-eye and right-eye images, which form the 3D image signal supplied from the frame rate conversion unit 25 to the memory controller 26, from the memory 27, and to supply the read image to the frame rate conversion unit 25. Then, the L/R image alternate-read instruction unit 63 supplies, to one of the input terminals of the selector 65, the L/R image alternate-read instruction command to alternately read the left-eye and right-eye images from the memory 27 and to supply the read mage to the frame rate conversion unit 25. The L image repeat-read instruction unit 64 outputs an L image repeat-read instruction command to read only the left-eye image between the left-eye and right-eye images, which form the 3D image signal supplied from the frame rate conversion unit 25 to the memory controller 26, from the memory 27 and to supply the read left-eye image to the frame rate conversion unit 25. Then, the L image repeat-read instruction unit 64 supplies, to the other input terminal of the selector 65, the repeat-read instruction command to read only the left-eye image between the left-eye and right-eye images from the memory 27 and to supply the read left-eye image to the frame rate conversion unit 25. The selector 65 changes the read control signal of one of the L/R image alternate-read instruction command or the L image repeat-read instruction command based on the non-standard signal determination flag, and then outputs the changed read control signal to the memory controller 26.

Relation between Input Signals and Output Signals in Detection Result Determination Unit

FIG. 4 shows a relation between the LR flag detection result and the non-standard signal determination flag, which are input signals, and the read controls signal and the LR flag selection control signal, which are output signals, in the detection result determination unit 22.

That is, when the non-standard signal determination flag is the Low signal indicating normality and the LR flag detection result is the Low signal indicating abnormality, the read controls signal is the Low signal (0) indicating the L/R image alternate-read instruction command and the LR flag selection control signal is the High signal (1). That is, in this case, based on this LR flag selection control signal, the selector 24 selects the LR flag self-running signal generated by the LR flag self-running signal generation unit 23 and supplies the selected LR flag self-running signal to the frame rate conversion unit 25. Further, when the non-standard signal determination flag is the Low signal indicating normality and the LR flag detection result is the High signal indicating normality, the read controls signal is the Low signal (0) indicating the L/R image alternate-read instruction command and the LR flag selection control signal is the Low signal (0). That is, in this case, based on this LR flag selection control signal, the selector 24 selects the LR flag input signal and supplies the selected LR flag input signal to the frame rate conversion unit 25.

When the non-standard signal determination flag is the High signal indicating non-standard and the LR flag detection result is the Low signal indicating abnormality, the read control signal is the High signal (1) indicating the L image repeat-read instruction command and the LR flag selection control signal is the Low signal (0). That is, in this case, based on this LR flag selection control signal, the selector 24 selects the LR flag input signal and supplies the selected LR flag input signal to the frame rate conversion unit 25. Further, when the non-standard signal determination flag is the High signal indicating non-standard and the LR flag detection result is the High signal indicating normality, the read control signal is the High signal (1) indicating the L image repeat-read instruction command and the LR flag selection control signal is the Low signal (0). That is, in this case, based on this LR flag selection control signal, the selector 24 selects the LR flag input signal and supplies the selected LR flag input signal to the frame rate conversion unit 25.

### Example of Configuration of LR Flag Self-running Signal Generation Unit

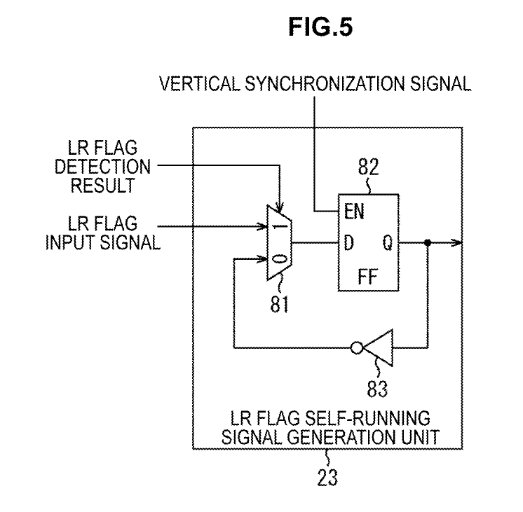

Next, an example of the configuration of the LR flag self-running signal generation unit 23 will be described with reference to FIG. 5.

The LR flag self-running signal generation unit 23 includes a selector 81, an FF 82, and an inversion circuit 83. The selector 81 outputs the LR flag input signal, when there is no abnormality in the LR flag input signal based on the LR flag detection result. Conversely, the selector 81 supplies the FF 82 with one of the signals obtained by inverting the output signal from the FF 82 by the inversion circuit 83. The FF 82 latches the signal supplied from the selector 81 at the supply timing of the vertical synchronization signal to an enable terminal EN, and supplies the latched signal as the LF flag self-running signal from an output terminal Q to the selector 24 and the inversion circuit 83. The LR flag self-running signal generation unit 23 outputs the LR flag input signal without change, as long as there is no abnormality in the LR flag input signal. Even when there is abnormality in the LR flag input signal, the FF 82 and the inversion circuit 83 themselves generate and output the LR flag self-running signal.

### LR Flag Detection Process

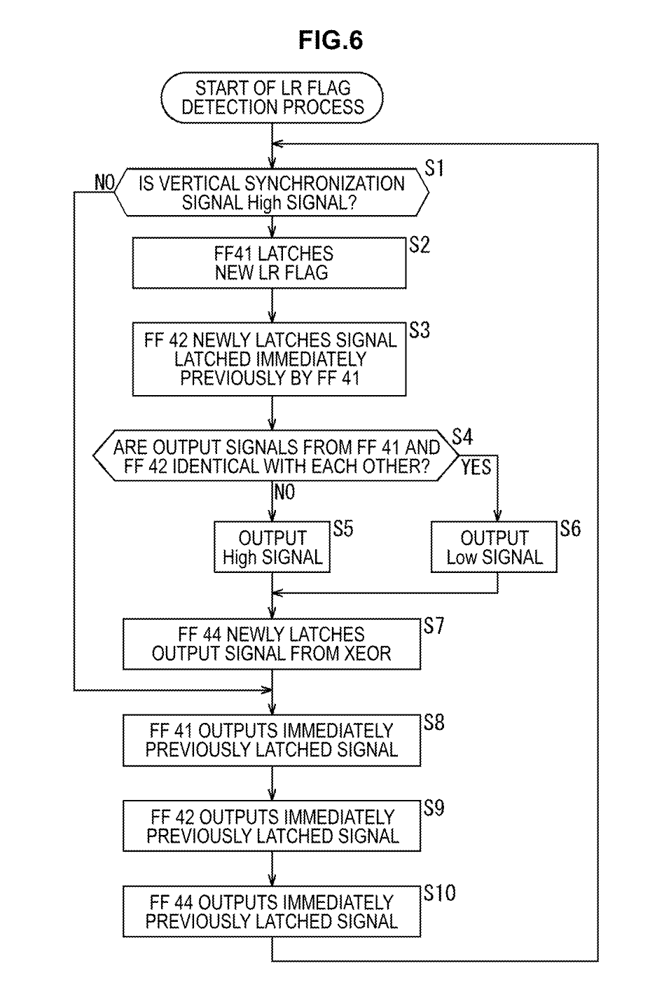

Next, an LR flag detection process will be described with reference to the flowchart of FIG. 6.

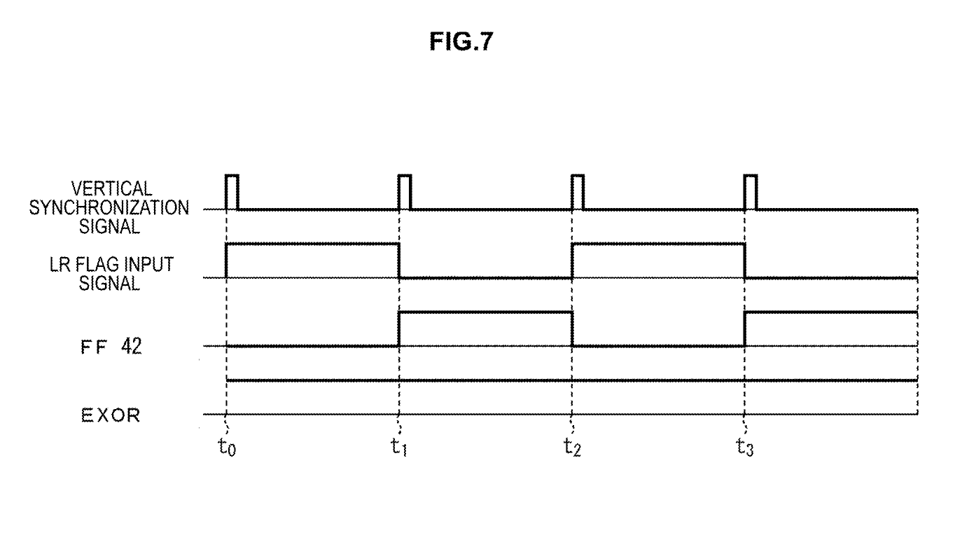

In step S1, the FF 41 and the FF 42 determine whether the vertical synchronization signal is supplied to both the enable terminals EN. In step S1, when the vertical synchronization signal is generated, for example, as shown at time t1 in the timing chart of FIG. 7, the process proceeds to step S2. FIG. 7 shows the vertical synchronization signal, the LR flag input signal supplied to the FF 41, the signal output from the FF 42, and the output signal from the EXOR circuit in order from the upper side.

In step S2, the FF 41 latches and stores a new LF flag input signal input together with the vertical synchronization signal. That is, when the LR flag input signal is changed from the High signal to the Low signal at time t1 in FIG. 7, the FF 41 latches and stores the new Low signal, and outputs the new Low signal to the EXOR circuit 43.

In step S3, the FF 42 latches and stores the signal input together with the vertical synchronization signal and output from the FF 41. That is, since the FF 41 outputs the High signal at time t1 in FIG. 7, the FF 42 latches and stores the High signal and outputs the latched High signal to the EXOR circuit 43.

In step S4, the EXOR circuit 43 compares the output signals from the FF 41 and FF 42 to each other to determine whether the output signals are identical with each other. For example, at time t1 in FIG. 7, the output signal from the FF 41 is the Low signal and the output signal from the FF 42 is the High signal. Therefore, since the output signals are not identical with each other in step S4, the process proceeds to step S5.

In step S5, the EXOR circuit 43 supplies the High signal indicating normality to the FF 44.

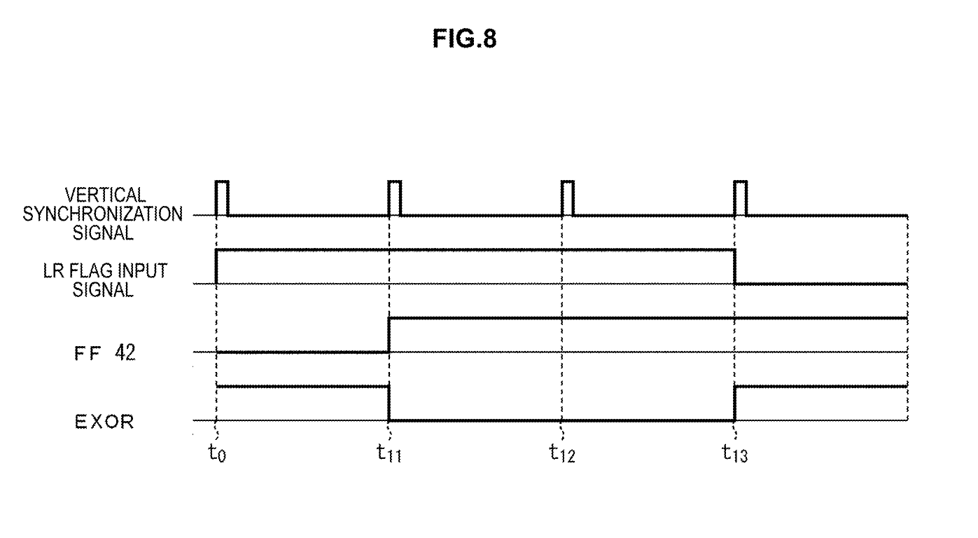

When the LR flag input signal is not inverted from the High signal to the Low signal in step S2, for example, as shown at time t11 in FIG. 8, the output signal from the output terminal Q of the FF 42 becomes the High signal in step S3. At time t12, the output signal from the output terminal Q of the FF 42 also becomes the High signal. As a result, during time t12 to time t14, the signals output from the FF 41 and the FF 42 are not identical with each other in step S4. Therefore, the process proceeds to step S6 and the EXOR circuit 43 outputs the Low signal, as shown in the fourth stage of FIG. 8.

In step S7, the FF 44 latches and stores the output signal of the EXOR circuit 43 applied to a data terminal thereof.

In step S8, the FF 41 outputs the immediately previously latched signal from the output terminal Q.

In step S9, the FF 42 outputs the immediately previously latched signal from the output terminal Q.

In step S10, the FF 44 outputs the immediately previously latched signal from the output terminal Q, and then the process returns to step S1.

When the vertical synchronization signal is considered not to be supplied in step S1, the processes of steps S2 to S7 are repeated.

It is determined whether the left-eye and right-eye images are switched and supplied in synchronization with the vertical synchronization signal through the above-described process. When the left-eye and right-eye images are not correctly switched and supplied, the LR flag input signal of the Low signal indicating the abnormality is output as the LR flag detection result. Conversely, when the left-eye and right-eye images are switched and supplied in synchronization with the vertical synchronization signal, the LR flag input signal of the High signal indicating normality is output as the LR flag detection result. As a result, by detecting the LR flag detection result, it can be known whether the LR flag input signal is correctly supplied.

### LR Flag Self-running Generation Process

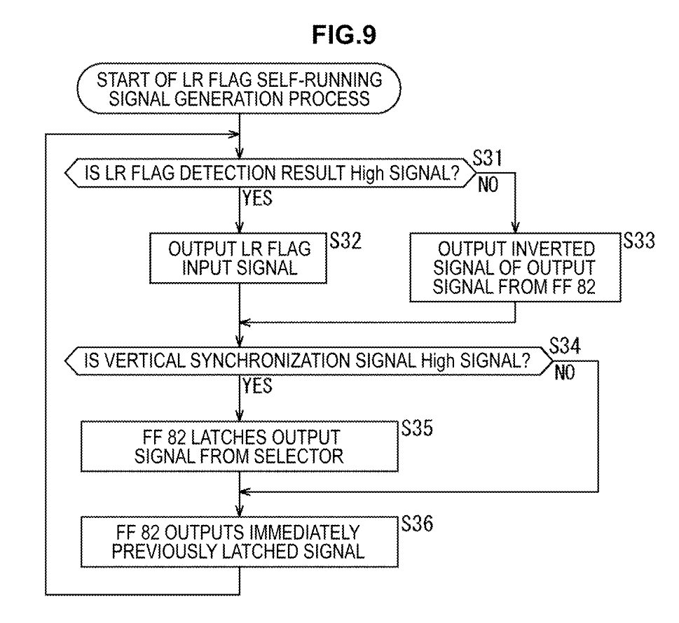

Next, an LR flag self-running signal generation process of the LR flag self-running signal generation unit 23 will be described with reference to the flowchart of FIG. 9.

In step S31, the selector 81 determines whether the LR flag detection result is the High signal, that is, whether the LR flag input signal is supplied correctly and normally. For example, when the LR flag detection result is the High signal and is normal in step S31, the process proceeds to step S32.

In step S32, the selector 81 supplies the LR flag input signal to the FF 82.

In step S34, the FF 82 determines whether the vertical synchronization signal is supplied to the enable terminal EN. For example, when the vertical synchronization signal is supplied in step S34, the process proceeds to step S35.

In step S35, the FF 82 latches and stores the signal supplied from the selector 81 to the data terminal D.

In step S36, the FF 82 outputs the immediately previously latched signal as the LR flag self-running signal from the output terminal Q and supplies the latched signal to the inversion circuit 83. Then, the inversion circuit 83 determines whether the supplied signal is the High signal or the Low signal, and then supplies the result to the selector 81. That is, when it is determined that the LR flag input signal is considered to be normal, the LR flag input signal is output as the LR flag self-running signal without change.

Conversely, when the LR flag detection result is the Low signal and the LR flag input signal is not correctly supplied in step S31, the process proceeds to step S33.

In step S33, the selector 81 selects the inverted signal of the output terminal Q of the FF 82 supplied from the inversion circuit 83 and outputs the inverted signal to the FF 82.

When the vertical synchronization signal is not the High signal in step S34, the process of step S35 is skipped.

Through the above-described processes, the LR flag input signal is output to be processed later, when there is no abnormality in the LR flag input signal. When there is abnormality in the LR flag input signal, the LR flag self-running signal considered as the signal substantially identical with the LR flag input signal can be generated by alternately outputting the signal output from the FF 82 in synchronization with the vertical synchronization signal and the signal inverted and input by the inversion circuit 83.

### Detection Result Determination Process

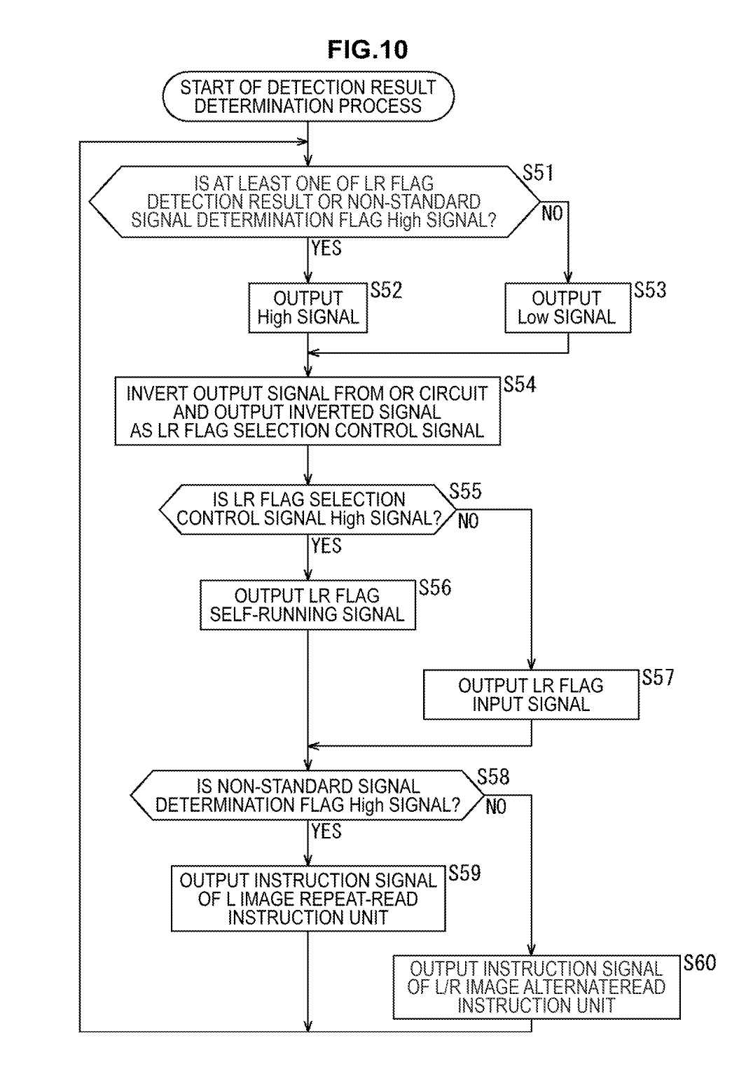

Next, a detection result determination process of the detection result determination unit 22 and the selector 24 will be described with reference to the flowchart of FIG. 10.

In step S51, the OR circuit 61 determines whether at least one of the LR flag detection result or the non-standard signal determination flag is the High signal. When at least one of the LR flag detection result or the non-standard signal determination flag is the High signal in step S51, the OR circuit 61 supplies the High signal to the inversion circuit 62 in step S52. Conversely, when both of the LR flag detection result and the non-standard signal determination flag are not the High signal but the Low signal in step S51, the OR circuit 61 supplies the Low signal to the inversion circuit 62 in step S53.

In step S54, the inversion circuit 62 inverts the determination result supplied from the OR circuit 61 and supplies the inverted determination result as the LR flag selection control signal to the selector 24.

In step S55, the selector 24 determines whether the LR flag selection control signal is the High signal. The process proceeds from step S55 to step S56, for example, when both of the LR flag detection result and the non-standard signal determination result are not the High signal in the process of step S51, the Low signal is output in the process of step S53, and the Low signal is inverted and the LR flag selection control signal is output as the High signal in the process of step S54.

In step S56, the selector 24 considers that the LR flag input signal is not correctly read and supplies the LR flag self-running signal generated by the LR flag self-running signal generation unit 23 to the frame rate conversion unit 25.

Conversely, the process proceeds from step S55 to step S57, for example, when at least one of the LR flag detection result or the non-standard signal determination flag is the High signal in the process of step S51, the High signal is output in the process of step S52, and the High signal is inverted and the LR flag selection control signal is output as the Low signal in the process of step S54.

In step S57, the selector 24 considers that the LR flag input signal is correctly read and supplies the LR flag input signal to the frame rate conversion unit 25 without change.

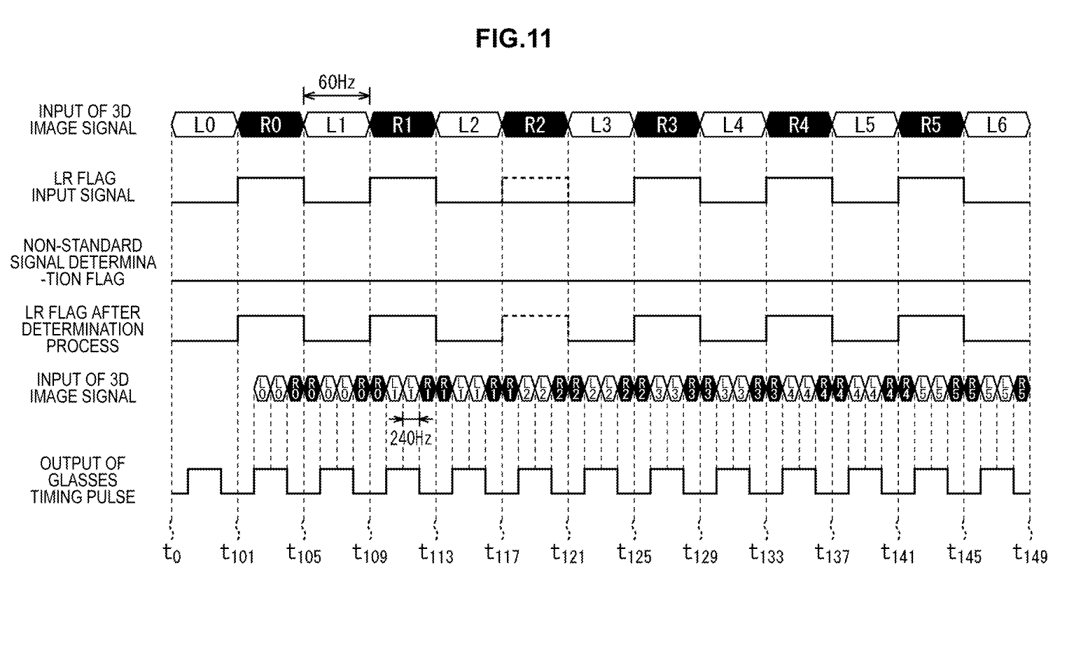

That is, as shown at time t101 to time t117 in the second stage of FIG. 11, the LR flag input signal is correctly supplied since the High signal and the Low signal are alternately input at a correct interval. In this case, the LR flag detection result becomes the High signal. Further, as shown in the third stage, the non-standard determination flag remains as the Low signal, and thus the LR flag selection control signal becomes the Low signal. In this case, in step S57, the LR flag input signal is supplied to the frame rate conversion unit 25 without change. Conversely, as shown at time t117 to time t121 in the second stage of FIG. 11, the LR flag input signal is not correctly supplied since the Low signal is input at a timing at which the High signal has to be originally output. In this case, the LR flag detection result becomes the Low signal. Further, as shown in the third stage, the LR flag selection control signal becomes the High signal since the non-standard determination flag remains to be the Low signal. In this case, a waveform indicated by a dotted portion in the fourth stage of FIG. 11 is supplemented and generated by the LR flag self-running signal through the process of step S56, and the supplemented waveform is supplied to the frame rate conversion unit 25.

Input of the 3D image signal is shown in the upper side of FIG. 11. LN and RN denote the left-eye and right-eye images of an n-th frame, respectively. The LR flag input signal, non-standard signal determination flag, output of the 3D image signal, and output of a glasses timing pulse are shown below the input of the 3D image signal from the upper side. The left-eye and right-eye images are alternately input at 60 Hz when the 3D image signal is input, whereas the two same images are continuously output at 240 Hz so that the left-eye and right-eye images are output twice alternately when the 3D image signal is output.

In step S58, the selector 65 determines whether the non-standard signal determination flag is the High signal, that is, whether there is a high probability that the 3D image signal is not correctly input. The process proceeds to step S59, when the non-standard signal determination flag is the High signal, that is, there is a high probability that the 3D image signal is not correctly input in step S58.

In step S59, the selector 65 selects the L image repeat-read instruction command from the L image repeat-read instruction unit 64 as the read control signal, and then outputs the read control signal to the memory controller 26. That is, in this case, since there is a high probability that the 3D image signal is not correctly input, the memory controller 26 performs a control process of reading only the left-eye image to prevent an error from occurring in the image.

Conversely, the process proceeds to step S60, when the non-standard signal determination flag is the Low signal, that is, there is a high probability that the 3D image signal is correctly input in step S58.

In step S60, the selector 65 selects the L/R image alternate-read instruction command from the L/R image alternate-read instruction unit 63 as the read control signal, and then outputs the read control signal to the memory controller 26. That is, in this case, since there is a high probability that the 3D image signal is correctly input, the memory controller 26 performs a control process of reading two left-eye image and two right-eye images twice alternately.

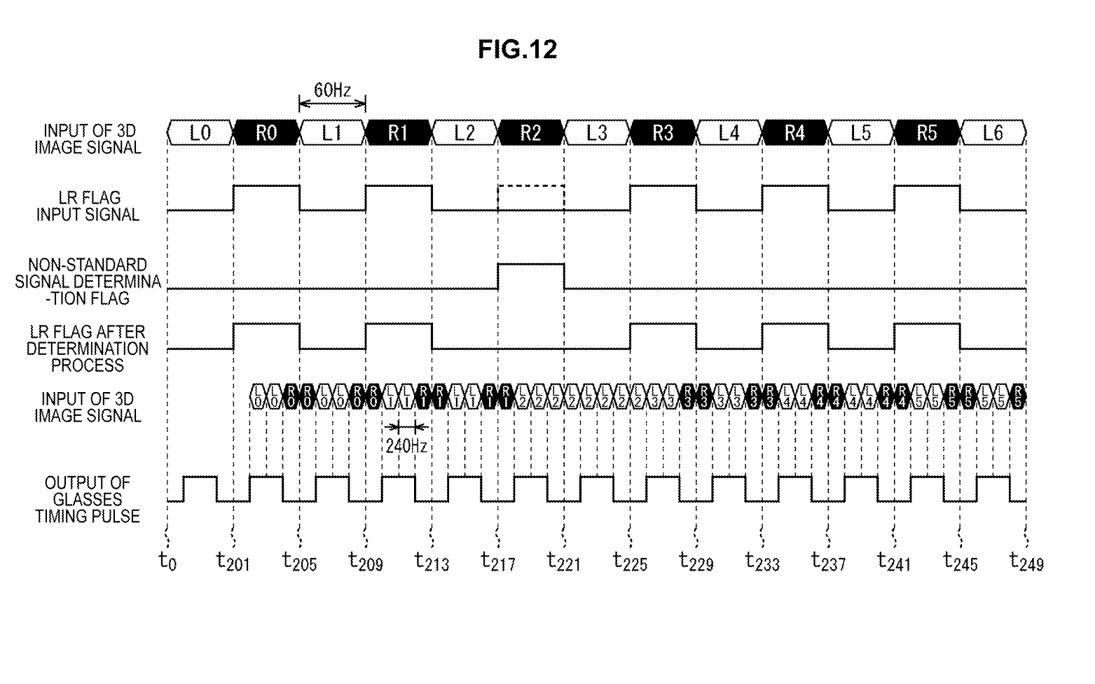

For example, the non-standard signal determination flag becomes the High signal at time t217 to time t221 through the process, as shown at time t217 to time t226 in FIG. 12. Further, the L image repeat-read instruction command is supplied to the frame rate conversion unit 25 through the process of step S59, and thus the right-eye image R2 supplied at the supply timing of the L image repetition reading instruction command is stopped from being read. Therefore, since the left-eye image L2 is output instead of the right-eye image R2 which has to be originally read at the timings of time t220 to time t222 and time t224 to time t226, only the left-eye image is thus read.

Only the left-eye image can be read and displayed through the detection result determination process, when there is a high probability that the 3D image signal is not input at the correct timing. Therefore, it is possible to prevent crosstalk or the like from occurring. Further, since this process is a process of preventing crosstalk occurring when a 3D stereoscopic view is realized by the left-eye and right-eye images, only the right-eye image may be read and displayed instead of reading and displaying only the left-eye image.

### Image Output Process

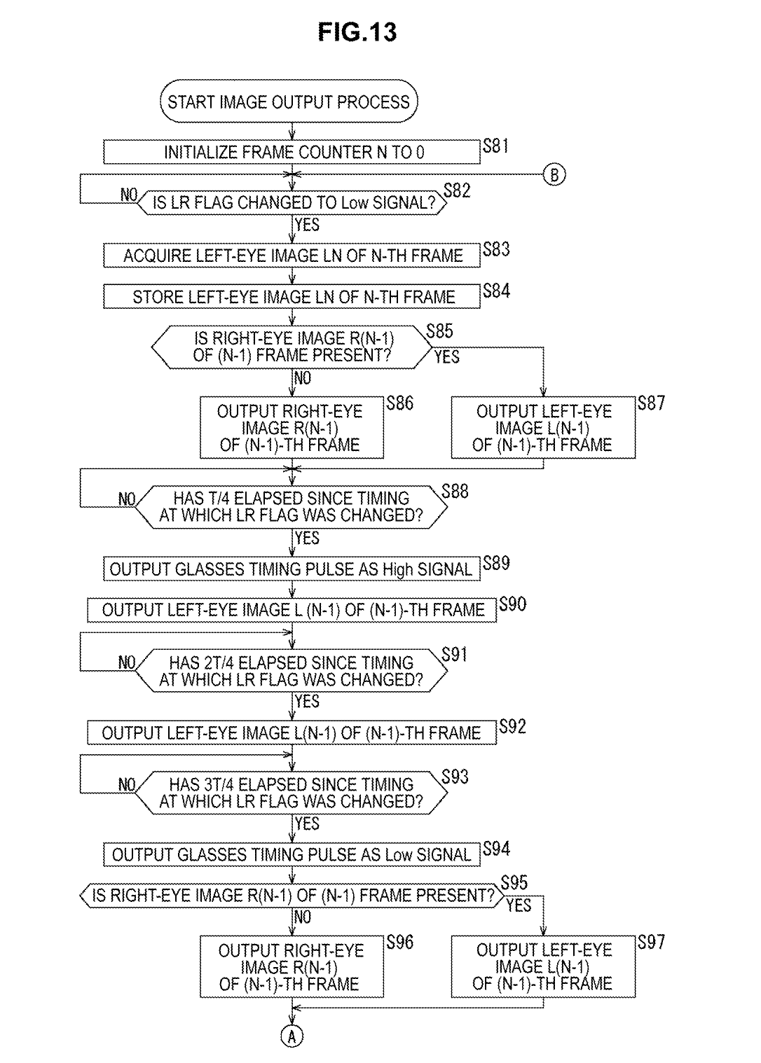

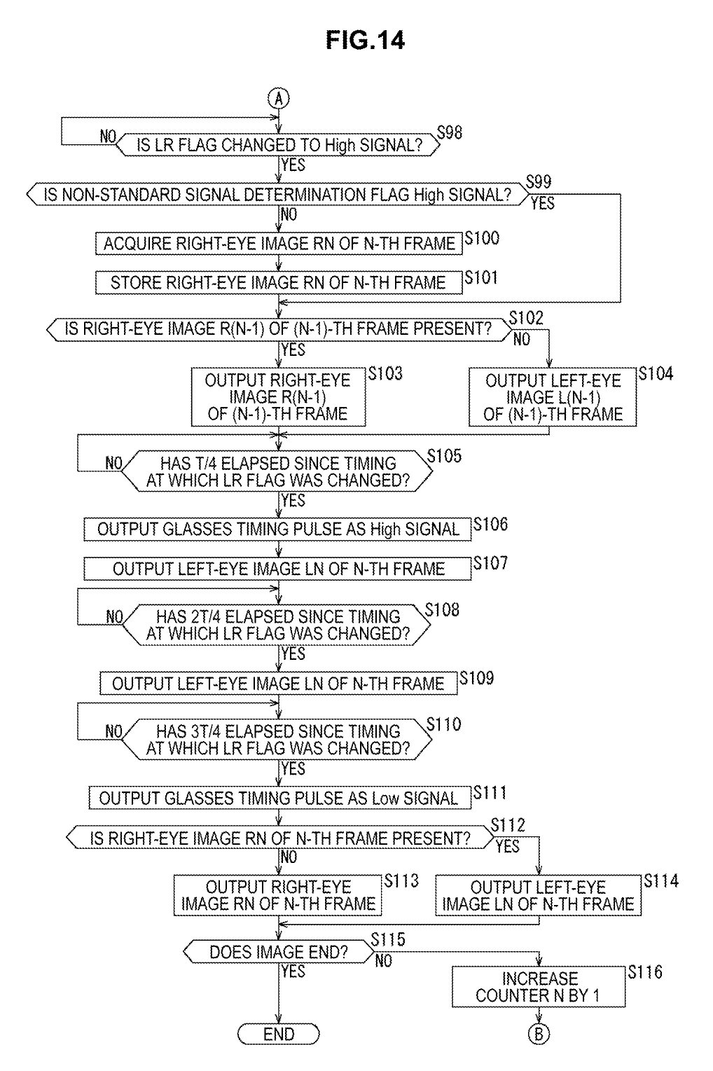

Next, an image output process will be described with reference to the flowcharts of FIGS. 13 and 14.

In step S81, the frame rate conversion unit 25 resets and initializes a frame counter N (not shown) to 0.

In step S82, the frame rate conversion unit 25 determines whether the LR flag input signal or the LR flag self-running signal supplied from the selector 24 is changed from the High signal to the Low signal. For example, when the frame counter N is equal to 1 and the LR flag input signal or the LR flag self-running signal is changed from the High signal to the Low signal, as shown at time t205 in the uppermost stage of FIG. 12, the process proceeds to step S83.

In step S83, the frame rate conversion unit 25 acquires the left-eye image LN of the N-th frame supplied at the timing and supplies the acquired left-eye image LN of the N-th frame to the memory controller 26.

In step S84, the memory controller 26 stores the supplied left-eye image LN of the N-th frame in the memory 27. That is, in this case, the memory controller 26 stores the supplied left-eye image L1 in the memory 27 at time t205 to time t209.

In step S85, the memory controller 26 determines whether the right-eye image R(N−1) of the (N−1)-th frame is stored in the memory 27. For example, when the right-eye image R(N−1) of the (N−1)-th frame is stored in the memory 27 in step S85, the memory controller 26 reads the right-eye image R(N−1) of the (N−1)-th frame from the memory 27 and supplies the read right-eye image R(N−1) of the (N−1)-th frame to the frame rate conversion unit 25 in step S86. The frame rate conversion unit 25 outputs the supplied right-eye image R(N−1) of the (N−1)-th frame. That is, in this case, since the frame counter N is equal to 1, the right-eye image R0 of the 0-th frame is output, as shown at time t205 and time t206 in the fifth stage of FIG. 12.

In step S88, the frame controller 25 controls the clock generation unit 25a and determines whether a time T/4 has elapsed since the timing at which the LR flag input signal or the LR flag self-miming signal was changed from the High signal to the Low signal. Here, the time T refers to a time interval at which the left-eye image LN or the right-eye image RN is supplied at 60 Hz. The same process is repeated, until the time T/4 has elapsed since the timing at which the LR flag input signal or the LR flag self-running signal was changed from the High signal to the Low signal in step S88. When the time T/4 has elapsed since the timing at which the LR flag input signal or the LR flag self-running signal was changed from the High signal to the Low signal in step S88, the process proceeds to step S89.

In step S89, the frame rate conversion unit 25 notifies the glasses timing pulse output unit 28 that the time T/4 has elapsed since the timing at which the LR flag input signal or the LR flag self-running signal was changed from the High signal to the Low signal. When the glasses timing pulse output unit 28 is notified, for example, the glasses timing pulse output unit 28 changes the glasses timing pulse to the High signal and outputs the changed glasses timing pulse, as shown at time t206 in the sixth stage of FIG. 12.

In step S90, the memory controller 26 reads the left-eye image L(N−1) of the (N−1)-th frame from the memory 27 and supplies the read left-eye image L(N−1) of the (N−1)-th frame to the frame rate conversion unit 25. The frame rate conversion unit 25 outputs the supplied left-eye image L(N−1) of the (N−1)-th frame. That is, in this case, since the frame counter N is equal to 1, the left-eye image L0 of the 0-th frame is output, as shown at time t206 and time t207 in the fifth stage of FIG. 12.

In step S91, the frame controller 25 controls the clock generation unit 25a and determines whether a time 2T/4 has elapsed since the timing at which the LR flag input signal or the LR flag self-running signal was changed from the High signal to the Low signal. The same process is repeated, until the time 2T/4 has elapsed since the timing at which the LR flag input signal or the LR flag self-running signal was changed from the High signal to the Low signal in step S91. When the time 2T/4 has elapsed since the timing at which the LR flag input signal or the LR flag self-running signal was changed from the High signal to the Low signal in step S91, the process proceeds to step S92.

In step S92, the memory controller 26 reads the left-eye image L(N−1) of the (N−1)-th frame from the memory 27 and supplies the read left-eye image L(N−1) of the (N−1)-th frame to the frame rate conversion unit 25. The frame rate conversion unit 25 outputs the supplied left-eye image L(N−1) of the (N−1)-th frame. That is, in this case, since the frame counter N is equal to 1, the left-eye image L0 of the 0-th frame is output, as shown at time t207 and time t208 in the fifth stage of FIG. 12.

In step S93, the frame controller 25 controls the clock generation unit 25a and determines whether a time 3T/4 has elapsed since the timing at which the LR flag input signal or the LR flag self-running signal was changed from the High signal to the Low signal. The same process is repeated, until the time 3T/4 has elapsed since the timing at which the LR flag input signal or the LR flag self-running signal was changed from the High signal to the Low signal in step S93. When the time 3T/4 has elapsed since the timing at which the LR flag input signal or the LR flag self-running signal was changed from the High signal to the Low signal in step S93, the process proceeds to step S94.

In step S94, the frame rate conversion unit 25 notifies the glasses timing pulse output unit 28 that the time 3T/4 elapsed from the timing at which the LR flag input signal or the LR flag self-running signal is changed from the High signal to the Low signal. When the glasses timing pulse output unit 28 is notified, for example, the glasses timing pulse output unit 28 changes the glasses timing pulse to the Low signal and outputs the changed glasses timing pulse, as shown at time t208 in the sixth stage of FIG. 12.

In step S95, the memory controller 26 determines whether the right-eye image R(N−1) of the (N−1)-th frame is stored in the memory 27. For example, when the right-eye image R(N−1) of the (N−1)-th frame is stored in the memory 27 in step S95, the memory controller 26 reads the right-eye image R(N−1) of the (N−1)-th frame from the memory 27 and supplies the read right-eye image R(N−1) of the (N−1)-th frame to the frame rate conversion unit 25 in step S96. The frame rate conversion unit 25 outputs the supplied right-eye image R(N−1) of the (N−1)-th frame. That is, in this case, since the frame counter N is equal to 1, the right-eye image R0 of the 0-th frame is output, as shown at time t208 and time t209 in the fifth stage of FIG. 12.

In step S98 (see FIG. 14), the frame rate conversion unit 25 determines whether the LR flag input signal or the LR flag self-running signal supplied from the selector 24 is changed from the Low signal to the High signal. For example, when the frame counter N is equal to 1 and the LR flag input signal or the LR flag self-running signal is changed from Low High signal to the High signal, as shown at time t209 in the uppermost stage of FIG. 12, the process proceeds to step S99.

In step S99, the memory controller 26 determines whether the read control signal is the L image repeat-read instruction command. For example, when the read control signal is not the L image repeat-read instruction command but the L/R image alternate-read instruction command, the process proceeds to step S100.

In step S100, the frame rate conversion unit 25 acquires the right-eye image RN of the N-th frame supplied at the timing and supplies the acquired right-eye image RN of the N-th frame to the memory controller 26.

In step S101, the memory controller 26 stores the supplied right-eye image RN of the N-th frame in the memory 27. That is, in this case, the memory controller 26 stores the supplied right-eye image R1 in the memory 27 at time t209 to time t213.

In step S102, the memory controller 26 determines whether the right-eye image R(N−1) of the (N−1)-th frame is stored in the memory 27. For example, when the right-eye image R(N−1) of the (N−1)-th frame is stored in the memory 27 in step S102, the memory controller 26 reads the right-eye image R(N−1) of the (N−1)-th frame from the memory 27 and supplies the read right-eye image R(N−1) of the (N−1)-th frame to the frame rate conversion unit 25 in step S103. The frame rate conversion unit 25 outputs the supplied right-eye image R(N−1) of the (N−1)-th frame. That is, in this case, since the frame counter N is equal to 1, the right-eye image R0 of the 0-th frame is output, as shown at time t209 and time t210 in the fifth stage of FIG. 12.

In step S105, the frame controller 25 controls the clock generation unit 25a and determines whether the time T/4 has elapsed since the timing at which the LR flag input signal or the LR flag self-running signal was changed from the High signal to the Low signal. The same process is repeated, until the time T/4 has elapsed since the timing at which the LR flag input signal or the LR flag self-running signal was changed from the High signal to the Low signal in step S105. When the time T/4 has elapsed since the timing at which the LR flag input signal or the LR flag self-running signal was changed from the High signal to the Low signal in step S105, the process proceeds to step S106.

In step S106, the frame rate conversion unit 25 notifies the glasses timing pulse output unit 28 that the time T/4 has elapsed since the timing at which the LR flag input signal or the LR flag self-running signal was changed from the High signal to the Low signal. When the glasses timing pulse output unit 28 is notified, for example, the glasses timing pulse output unit 28 changes the glasses timing pulse to the High signal and outputs the changed glasses timing pulse, as shown at time t210 in the sixth stage of FIG. 12.

In step S107, the memory controller 26 reads the left-eye image LN of the N-th frame from the memory 27 and supplies the read left-eye image LN of the N-th frame to the frame rate conversion unit 25. The frame rate conversion unit 25 outputs the supplied left-eye image LN of the N-th frame. That is, in this case, since the frame counter N is equal to 1, the left-eye image L1 of the 1st frame is output, as shown at time t210 and time t211 in the fifth stage of FIG. 12.

In step S108, the frame controller 25 controls the clock generation unit 25a and determines whether the time 2T/4 has elapsed since the timing at which the LR flag input signal or the LR flag self-running signal was changed from the High signal to the Low signal. The same process is repeated, until the time 2T/4 has elapsed since the timing at which the LR flag input signal or the LR flag self-running signal was changed from the High signal to the Low signal in step S108. When the time 2T/4 has elapsed since the timing at which the LR flag input signal or the LR flag self-running signal was changed from the High signal to the Low signal in step S108, the process proceeds to step S109.

In step S109, the memory controller 26 reads the left-eye image LN of the N-th frame from the memory 27 and supplies the read left-eye image LN of the N-th frame to the frame rate conversion unit 25. The frame rate conversion unit 25 outputs the supplied left-eye image LN of the N-th frame. That is, in this case, since the frame counter N is equal to 1, the left-eye image L1 of the 1st frame is output, as shown at time t211 and time t212 in the fifth stage of FIG. 12.

In step S110, the frame controller 25 controls the clock generation unit 25a and determines whether the time 3T/4 has elapsed since the timing at which the LR flag input signal or the LR flag self-running signal was changed from the High signal to the Low signal. The same process is repeated, until the time 3T/4 has elapsed since the timing at which the LR flag input signal or the LR flag self-running signal was changed from the High signal to the Low signal in step S110. When the time 3T/4 has elapsed since the timing at which the LR flag input signal or the LR flag self-running signal was changed from the High signal to the Low signal in step S110, the process proceeds to step S111.

In step S111, the frame rate conversion unit 25 notifies the glasses timing pulse output unit 28 that the time 3T/4 has elapsed since the timing at which the LR flag input signal or the LR flag self-running signal was changed from the High signal to the Low signal. When the glasses timing pulse output unit 28 is notified, for example, the glasses timing pulse output unit 28 changes the glasses timing pulse to the Low signal and outputs the changed glasses timing pulse, as shown at time t212 in the sixth stage of FIG. 12.

In step S112, the memory controller 26 determines whether the right-eye image RN of the N-th frame is stored in the memory 27. For example, when the right-eye image RN of the N-th frame is stored in the memory 27 in step S112, the memory controller 26 reads the right-eye image RN of the N-th frame from the memory 27 and supplies the read right-eye image RN of the N-th frame to the frame rate conversion unit 25 in step S113. The frame rate conversion unit 25 outputs the supplied right-eye image RN of the N-th frame. That is, in this case, since the frame counter N is equal to 1, the right-eye image R1 of the 1st frame is output, as shown at time t212 and time t213 in the fifth stage of FIG. 12.

In step S115, the frame rate conversion unit 25 determines whether a new 3D image signal is not supplied and the 3D image signal ends. For example, when the frame rate conversion unit 25 determines that a new 3D image signal is supplied and the 3D image signal does not end in step S115, the frame rate conversion unit 25 increases the frame counter N by one in step S116, and then the process returns to step S82. That is, the processes of step S82 to step S116 are repeated, until the 3D image signal is not supplied. When the 3D image signal is not supplied, the process ends in step S115.

Conversely, for example, when the non-standard signal determination flag is the High signal, as shown at time t217 to time t221 in the third stage of FIG. 12, the frame counter N is equal to 2 here. Then, since the non-standard signal determination flag is considered as the High signal in step S99, the processes of steps S100 and S101 are skipped. That is, in this case, the memory controller 26 does not supply the right-eye image R2 to the memory 27. Accordingly, since the right-eye image RN of the N-th frame is not stored in the memory 27, the right-eye image RN of the N-th frame is not stored in step S112 and the process proceeds to step S114.

In step S114, the memory controller 26 reads the left-eye image LN of the N-th frame from the memory 27 and supplies the read left-eye image LN of the N-th frame to the frame rate conversion unit 25. The frame rate conversion unit 25 outputs the supplied left-eye image LN of the N-th frame. That is, in this case, since the frame counter N is equal to 2, the left-eye image L2 of the 2nd frame is output, as shown at time t220 and time t221 in the fifth stage of FIG. 12.

When the frame counter N is equal to 3, for example, the right-eye image R(N−1) of the (N−1)-th frame is not stored in the memory 27 in step S85 (see FIG. 13), and thus the process proceeds to step S87. In step S87, the memory controller 26 reads the left-eye image L(N−1) of the (N−1)-th frame from the memory 27 and supplies the read left-eye image L(N−1) of the (N−1)-th frame to the frame rate conversion unit 25. The frame rate conversion unit 25 outputs the supplied left-eye image L(N−1) of the (N−1)-th frame. That is, in this case, since the frame counter N is equal to 3, the left-eye image L2 of the 2nd frame is output, as shown at time t221 and time t222 in the fifth stage of FIG. 12.

For example, since the right-eye image R(N−1) of the (N−1)-th frame is not stored in the memory 27 in step S95, the process proceeds to step S97. In step S97, the memory controller 26 reads the left-eye image L(N−1) of the (N−1)-th frame from the memory 27 and supplies the read left-eye image L(N−1) of the (N−1)-th frame to the frame rate conversion unit 25. The frame rate conversion unit 25 outputs the supplied left-eye image L(N−1) of the (N−1)-th frame. That is, in this case, since the frame counter N is equal to 3, the left-eye image L2 of the 2nd frame is output, as shown at time t224 and time t225 in the fifth stage of FIG. 12.

Since the right-eye image R(N−1) of the (N−1)-th frame is also not stored in the memory 27 in step S102 (see FIG. 14), the process proceeds to step S104. In step S104, the memory controller 26 reads the left-eye image L(N−1) of the (N−1)-th frame from the memory 27 and supplies the read left-eye image L(N−1) of the (N−1)-th frame to the frame rate conversion unit 25. The frame rate conversion unit 25 outputs the supplied left-eye image L(N−1) of the (N−1)-th frame. That is, in this case, since the frame counter N is equal to 3, the left-eye image L2 of the 2nd frame is output, as shown at time t225 and time t226 in the fifth stage of FIG. 12.

Through the above-described process, the 3D image signal supplied at the frame rate of 60 Hz can be converted into the 3D image signal of the frame rate of 240 Hz, which is four times 60 Hz, to be displayed, and the glasses timing pulse necessary for the display can be accurately supplied. In order to appropriately convert the frame rate, only the left-eye image is displayed without reading the right-eye image, when the non-standard signal determination flag is the High signal, that is, when there is a high probability that the 3D image signal is not accurately supplied. Therefore, it is possible to prevent crosstalk from occurring when the LR flag is not stable. At this time, even when the LR flag detection result is the Low signal and the LR flag input signal is not correct by the LR flag detection result, it is possible to output the 3D image signal and display the 3D image at the accurate timing by generating the LR flag self-running signal instead of the LR flag input signal.

The foregoing description pertains to a case in which the frame rate of the input of the 3D image signal is set to 60 Hz and the frame rate of the output of the 3D image signal is set to 240 Hz. However, any frame rate may, of course, be used. Further, the foregoing description pertains to a case in which only the left-eye image is displayed when there is a high probability that the 3D image signal is not supplied as the correct LR flag. However, since the output of the 3D image formed by the left-eye and right-eye images is just stopped, only the right-eye image may be displayed.

According to the embodiments of the present technology, an image can be viewed without error even when supply timings of left-eye and right-eye images configured to realize a three-dimensional view are disturbed.

The above-described series of processes may be executed by hardware or software. When the series of processes are performed by software, a program for the software is installed in a dedicated-hardware embedded computer and a general personal computer capable of executing various functions by installing various programs.

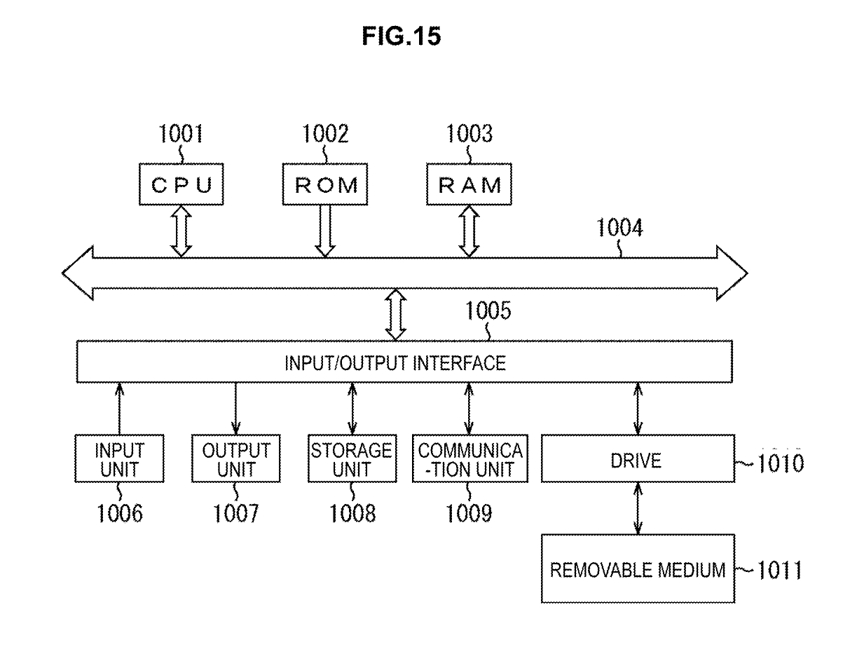

FIG. 15 is a diagram illustrating an example of the configuration of a general personal computer. The personal computer includes a central processing unit (CPU) 1001. An input/output interface 1005 is connected to the CPU 1001 via a bus 1004. the bus 1004 are connected to a read-only memory (ROM) 1002 and a random access memory (RAM) 1003.

The input/output interface 1005 is connected to an input unit 1006 configured by an input device such as a keyboard or a mouse through which a user inputs an operation command, an output unit 1007 outputting a processing operation screen or an image of a processing result to a display device, a storage unit 1008 configured by a hard disk drive or the like storing programs or various kinds of data, and a communication unit 1009 configured by a local area network (LAN) adapter and executing a communication process via a network such as the Internet. The input/output interface 1005 is connected to a drive 1010 reading and writing data on a removable medium 1011 such as a magnetic disk (including a flexible disk), an optical disc (including a compact disc-read only memory (CD-ROM) and a digital versatile disc (DVD)), a magneto-optical disc (including a mini disc (MD)), or a semiconductor memory.

The CPU 1001 executes various processes in accordance with a program stored in the ROM 1002 or a program read from the removable medium 1011 such as a magnetic disk, an optical disc, a magneto-optical disc, or a semiconductor memory, installed in the memory 1008, and loaded from the storage unit 1008 on the RAM 1003. In the RAM 1003, not only various processes are executed by the CPU 1001 but also necessary data or the like are appropriately stored.

Steps describing a program recorded on a recording medium include not only processes performed chronologically in the described order but also processes performed in parallel or separately even when the processes are not necessarily performed chronologically.

The present technology may also be configured as follows.

(1) An image processing apparatus that outputs, if three-dimensional stereoscopically viewable left-eye and right-eye images are not alternately supplied at accurate timings, only one of the three-dimensional stereoscopically viewable left-eye or right-eye image when the three-dimensional stereoscopically viewable left-eye and right-eye images are supplied.
(2) The image processing apparatus according to (1), further comprising:

a determination unit that determines, when the three-dimensional stereoscopically viewable left-eye and right-eye images are alternately supplied, whether timing signals indicating supply timings of the left-eye image and the right-eye image are correct; and

a timing signal generation unit that independently generates the supply timing signals,

wherein when the abnormal signal detection unit does not detect the signal indicating that the three-dimensional stereoscopically viewable left-eye and right-eye images are not alternately output at the accurate timings and the determination unit determines that the supply timing signals are not correct, the output unit acquires the three-dimensional stereoscopically viewable left-eye and right-eye images based on the timing signals generated by the timing signal generation unit and outputs the acquired three-dimensional stereoscopically viewable left-eye and right-eye images at predetermined timings.

(3) The image processing apparatus according to (2) or (3), wherein the output unit acquires the three-dimensional stereoscopically viewable left-eye and right-eye images based on the timing signals, and converts and outputs a frame rate.
(4) The image processing apparatus according to any one of (1) to (3), further comprising:

a storage unit that stores the three-dimensional stereoscopically viewable left-eye and right-eye images acquired by the output unit based on the timing signals; and

a storage control unit that stores the three-dimensional stereoscopically viewable left-eye and right-eye images acquired by the output unit in the storage unit based on the timing signals and, when the output unit converts and outputs the frame rate, reads one of the three-dimensional stereoscopically viewable left-eye or right-eye image stored in the storage unit and supplies the read image to the output unit.

(5) The image processing apparatus according to any one of (1) to (4), wherein when the abnormal signal detection unit detects the signal indicating that the three-dimensional stereoscopically viewable left-eye and right-eye images are not alternately output at the accurate timings, the storage control unit stores only one of the three-dimensional stereoscopically viewable left-eye or right-eye image acquired by the output unit in the storage unit based on the timing signals, reads only one of the three-dimensional stereoscopically viewable left-eye or right-eye image stored in the storage unit, and outputs the read image to the output unit, and

the output unit converts the frame rate and outputs only one of the left-eye or right-eye image.

(6) An image processing method comprising:

detecting, with an abnormal signal detection unit that detects a signal indicating that three-dimensional stereoscopically viewable left-eye and right-eye images are not alternately supplied at accurate timings, the signal indicating that the three-dimensional stereoscopically viewable left-eye and right-eye images are not alternately supplied at the accurate timings; and

outputting, with an output unit that outputs, if the abnormal signal detection unit detects the signal indicating that the three-dimensional stereoscopically viewable left-eye and right-eye images are not alternately output at the accurate timings, only one of the left-eye or right-eye image when the three-dimensional stereoscopically viewable left-eye and right-eye images are supplied, only one of the left-eye or right-eye image when the three-dimensional stereoscopically viewable left-eye and right-eye images are supplied if the signal indicating that the three-dimensional stereoscopically viewable left-eye and right-eye images are not alternately output at the accurate timings is detected by the process of the detecting step.

(7) A program causing a computer, which controls an image processing apparatus including an abnormal signal detection unit that detects a signal indicating that three-dimensional stereoscopically viewable left-eye and right-eye images are not alternately supplied at accurate timings, and an output unit that outputs, if the abnormal signal detection unit detects the signal indicating that the three-dimensional stereoscopically viewable left-eye and right-eye images are not alternately output at the accurate timings, only one of the left-eye or right-eye image when the three-dimensional stereoscopically viewable left-eye and right-eye images are supplied, to execute a process comprising:

detecting, with the abnormal signal detection unit, the signal indicating that the three-dimensional stereoscopically viewable left-eye and right-eye images are not alternately supplied at the accurate timings; and

if the signal indicating that the three-dimensional stereoscopically viewable left-eye and right-eye images are not alternately output at the accurate timings is detected by the process of the detecting step, outputting, with the output unit, only one of the left-eye or right-eye image when the three-dimensional stereoscopically viewable left-eye and right-eye images are supplied.

It should be understood by those skilled in the art that various modifications, combinations, sub-combinations and alterations may occur depending on design requirements and other factors insofar as they are within the scope of the appended claims or the equivalents thereof.

The present disclosure contains subject matter related to that disclosed in Japanese Priority Patent Application JP 2011-135623 filed in the Japan Patent Office on Jun. 17, 2011, the entire content of which is hereby incorporated by reference.

What is claimed is:

1. An image processing apparatus that outputs, if three-dimensional stereoscopically viewable left-eye and right-eye images are not alternately supplied at accurate timings, only one of the three-dimensional stereoscopically viewable left-eye or right-eye image when the three-dimensional stereoscopically viewable left-eye and right-eye images are supplied.

2. An image processing apparatus comprising:
an abnormal signal detection unit that detects a signal indicating that three-dimensional stereoscopically viewable left-eye and right-eye images are not alternately supplied at accurate timings; and
an output unit that outputs, when the abnormal signal detection unit detects the signal indicating that the three-dimensional stereoscopically viewable left-eye and right-eye images are not alternately output at the accurate timings, only one of the left-eye or right-eye image when the three-dimensional stereoscopically viewable left-eye and right-eye images are supplied.

3. The image processing apparatus according to claim 2, further comprising:
a determination unit that determines, when the three-dimensional stereoscopically viewable left-eye and right-eye images are alternately supplied, whether timing signals indicating supply timings of the left-eye image and the right-eye image are correct; and
a timing signal generation unit that independently generates the supply timing signals,
wherein when the abnormal signal detection unit does not detect the signal indicating that the three-dimensional stereoscopically viewable left-eye and right-eye images are not alternately output at the accurate timings and the determination unit determines that the supply timing signals are not correct, the output unit acquires the three-dimensional stereoscopically viewable left-eye and right-eye images based on the timing signals generated by the timing signal generation unit and outputs the acquired three-dimensional stereoscopically viewable left-eye and right-eye images at predetermined timings.

4. The image processing apparatus according to claim 2, wherein the output unit acquires the three-dimensional stereoscopically viewable left-eye and right-eye images based on the timing signals, and converts and outputs a frame rate.

5. The image processing apparatus according to claim 4, further comprising:
a storage unit that stores the three-dimensional stereoscopically viewable left-eye and right-eye images acquired by the output unit based on the timing signals; and
a storage control unit that stores the three-dimensional stereoscopically viewable left-eye and right-eye images acquired by the output unit in the storage unit based on the timing signals and, when the output unit converts and outputs the frame rate, reads one of the three-dimensional stereoscopically viewable left-eye or right-eye image stored in the storage unit and supplies the read image to the output unit.

6. The image processing apparatus according to claim 5, wherein when the abnormal signal detection unit detects the signal indicating that the three-dimensional stereoscopically viewable left-eye and right-eye images are not alternately output at the accurate timings, the storage control unit stores only one of the three-dimensional stereoscopically viewable left-eye or right-eye image acquired by the output unit in the storage unit based on the timing signals, reads only one of the three-dimensional stereoscopically viewable left-eye or right-eye image stored in the storage unit, and outputs the read image to the output unit, and
the output unit converts the frame rate and outputs only one of the left-eye or right-eye image.

7. An image processing method comprising:
detecting, with an abnormal signal detection unit that detects a signal indicating that three-dimensional stereoscopically viewable left-eye and right-eye images are not alternately supplied at accurate timings, the signal indicating that the three-dimensional stereoscopically viewable left-eye and right-eye images are not alternately supplied at the accurate timings; and
outputting, with an output unit that outputs, if the abnormal signal detection unit detects the signal indicating that the three-dimensional stereoscopically viewable left-eye and right-eye images are not alternately output at the accurate timings, only one of the left-eye or right-eye image when the three-dimensional stereoscopically viewable left-eye and right-eye images are supplied, only one of the left-eye or right-eye image when the three-dimensional stereoscopically viewable left-eye and right-eye images are supplied if the signal indicating that the three-dimensional stereoscopically viewable left-eye and right-eye images are not alternately output at the accurate timings is detected by the process of the detecting step.

8. A program causing a computer, which controls an image processing apparatus including an abnormal signal detection unit that detects a signal indicating that three-dimensional stereoscopically viewable left-eye and right-eye images are not alternately supplied at accurate timings, and an output unit that outputs, if the abnormal signal detection unit detects the signal indicating that the three-dimensional stereoscopically viewable left-eye and right-eye images are not alternately output at the accurate timings, only one of the left-eye or right-eye image when the three-dimensional stereoscopically viewable left-eye and right-eye images are supplied, to execute a process comprising:
detecting, with the abnormal signal detection unit, the signal indicating that the three-dimensional stereoscopically viewable left-eye and right-eye images are not alternately supplied at the accurate timings; and
if the signal indicating that the three-dimensional stereoscopically viewable left-eye and right-eye images are not alternately output at the accurate timings is detected by the process of the detecting step, outputting, with the output unit, only one of the left-eye or right-eye image when the three-dimensional stereoscopically viewable left-eye and right-eye images are supplied.
